(19) United States
(12) Patent Application Publication
(10) Pub. No.: US 2007/0295118 A1
(43) Pub. Date: Dec. 27, 2007

(54) Remote control car starter with engaging and disengaging structure

(76) Inventor: Daimler Chu, Sinjhuang City (TW)

Correspondence Address: TROXELL LAW OFFICE PLLC;SUITE 1404, 5205 LEESBURG PIKE, FALLS CHURCH, VA, 22041, US

(21) Appl. No.: 11/445,321

(22) Filed: Jun. 2, 2006

(51) Int. Cl. F02N 15/06

(52) U.S. Cl. 74/6

(57) ABSTRACT

The present invention is structured from a driving portion and a driven portion. The driving portion includes a case and a hollow shaft sleeve that is located on a circumference thereof. A shaft penetrates the shaft sleeve, and a top end of the shaft is provided with a sleeve joint portion. A driving bevel gear is configured to a bottom end of the shaft, and a spring is installed on a bottom end of the sleeve joint portion to positionally fix the driving bevel gear in the case. A through hole is defined in a cover body of the driven portion, and a central shaft penetrates the through hole. A driven bevel gear is configured to one end of the central shaft, and another end of the central shaft is connected to remote control car engine. The driving bevel gear and the driven bevel gear assume a normally disengaged state.

### BACKGROUND OF THE INVENTION

(a) Field of the Invention

The present invention relates to a remote control car starter with engaging and disengaging structure, and more particularly to a remote control car starter that enables a user to start an engine and cause a driving bevel gear of a starter to separate from and connect to a driven bevel gear of a engine rotor shaft without causing reduction in engine output power.

(b) Description of the Prior Art

Design of a conventional remote control car engine includes a cord that is pulled in order to start the engine. However, such a method to start the engine is not only difficult; moreover, it can result in injury to the hands of the user. This is extremely inconvenient to the user.

In order to resolve the aforementioned shortcomings in prior art engine starter methods, designs for remote control car engine ancillary starters became available on the market. For instance, Taiwan patent No. 242278, entitled “Improved Auxiliary Starter Structure for Engine of a Remote Controlled Car”, issued to the inventor of the present invention is characterized in having a structure comprising a driving gear set and a driven gear set. The driving gear set comprises a case and a hollow shaft sleeve that is located on a circumference of the case and assumes a 45 degree angle therewith; moreover, the hollow shaft sleeve forms a passageway with a holding portion. A shaft penetrates the hollow shaft sleeve, and a top end of the shaft is provided with a sleeve joint portion. A driving bevel gear is fitted to a bottom end of the shaft, which enables the driving bevel gear to be positionally fixed in the case. The driven gear set is provided with a cover body that covers the case. A through hole defined in the cover body enables a unilateral bearing to be installed therein. A central shaft penetrates the unilateral bearing, and a driven bevel gear, which meshes with the driving gear set, is fitted to one end of the central shaft. Moreover, another end of the central shaft is connected to a remote control engine. Accordingly, such a configuration enables a power tool inserted into the sleeve joint portion of the driving gear set to rotate the shaft, which further actuates rotation of the central shaft of the driven gear set, thereby starting the engine connected to the other end of the central shaft.

Accordingly, although the aforementioned cited invention achieves starting the engine by auxiliary electrical means. However, rotating motion of the engine after starting still causes the central shaft connected to the engine to rotate, and because the driven bevel gear at the end portion of the central shaft meshes with the driving bevel gear, thus, rotation is transmitted to the driving gear set. Consequently, power output of the engine is restrained by the driving gear set, which causes reduction in power output, and is thus still not an ideal configuration.

Hence, it is a feature of the present invention to provide a remote car starter with an engagement and disengagement structure for use by general consumers which overcomes the aforementioned shortcomings of prior art and attenuates reduction in engine power.

### SUMMARY OF THE INVENTION

A primary objective of the present invention is to provide a remote control car starter with engaging and disengaging structure that enables a user to start an engine of a remote control car by actuating a driving bevel gear of a starter, whereafter the driving bevel gear is able to disengage from a driven bevel gear connected to the engine, thereby releasing power output of the remote control car engine from being restrained by the driving portion, which would otherwise result in reduction in the output power.

In order to achieve the aforementioned objective, configuration of a remote control car starter provided with an engagement and disengagement structure of the present invention is structured to comprise a driving portion and a driven portion. The driving portion comprises a case provided with a hollow holding portion. A hollow shaft sleeve is located on a circumference of a case and assumes a 45 degree angle therewith; moreover, the hollow shaft sleeve forms a passageway with the holding portion. A shaft, a top end of which is provided with a sleeve joint portion; a bottom end of the shaft is configured with a driving bevel gear. Moreover, a spring is installed to a bottom end of the sleeve joint portion, which enables the driving bevel gear positionally fixed in the holding portion of the case and a driven bevel gear to assume a disengaged state. The driven bevel gear is configured with a cover, which is used to cover the holding portion of the aforementioned case. Moreover, a through hole is defined in the cover, and a shaft sleeve is installed in the through hole. A central shaft penetrates the shaft sleeve, and the driven bevel gear is configured to one end of the central shaft so as to enable meshing with the driving bevel gear. Another end of the central shaft is connected to a connecting portion of a remote control car engine, thereby aiding in starting the remote control car engine. Furthermore, after starting the remote control car engine, the elastic force effect of the spring separates the driving bevel gear from meshing with the driven bevel gear, thereby releasing output power of the remote control car engine from being restrained by the driving portion bevel gear, which would otherwise result in reduction in output power.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational schematic view of the present invention.

FIG. 2 shows an exploded structural schematic view according to the present invention.

FIG. 3 shows a cross-sectional view along line 3-3 of FIG. 1 of the present invention.

FIG. 4 shows a schematic view depicting setting up of the present invention.

FIG. 5 shows a schematic view depicting starting up according to the present invention.

FIG. 6 shows a schematic view depicting withdrawing of a power tool after starting up according to the present invention.

### DETAILED DESCRIPTION OF THE PREFERRED EMBODIMENTS

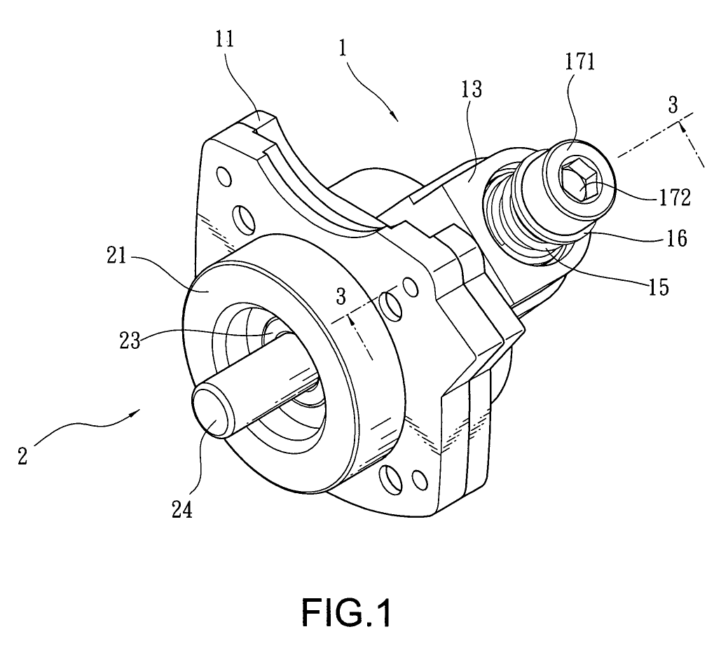

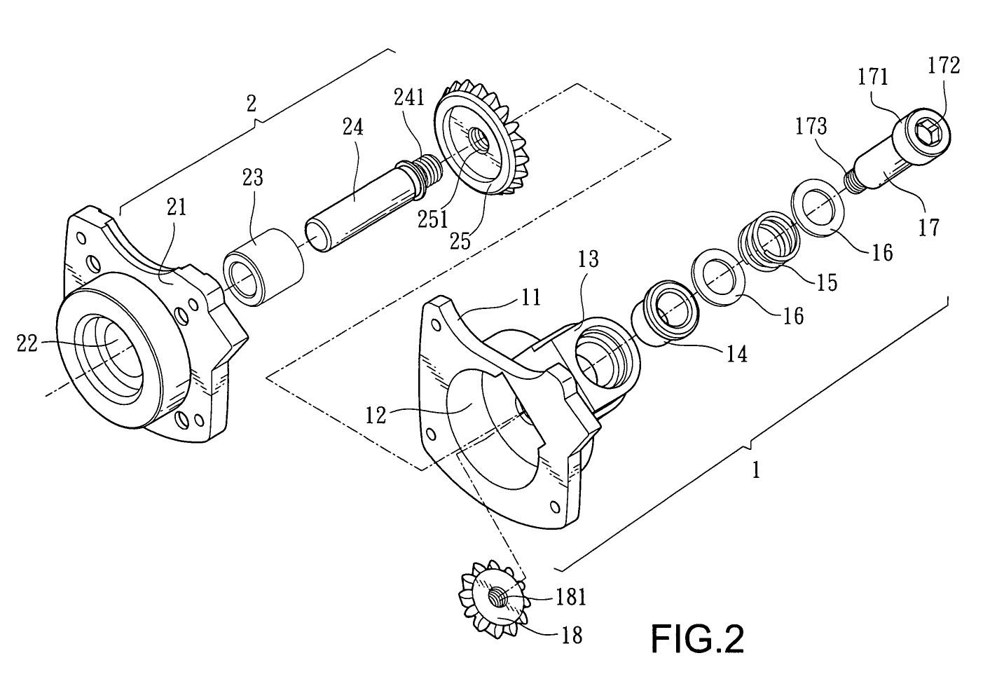

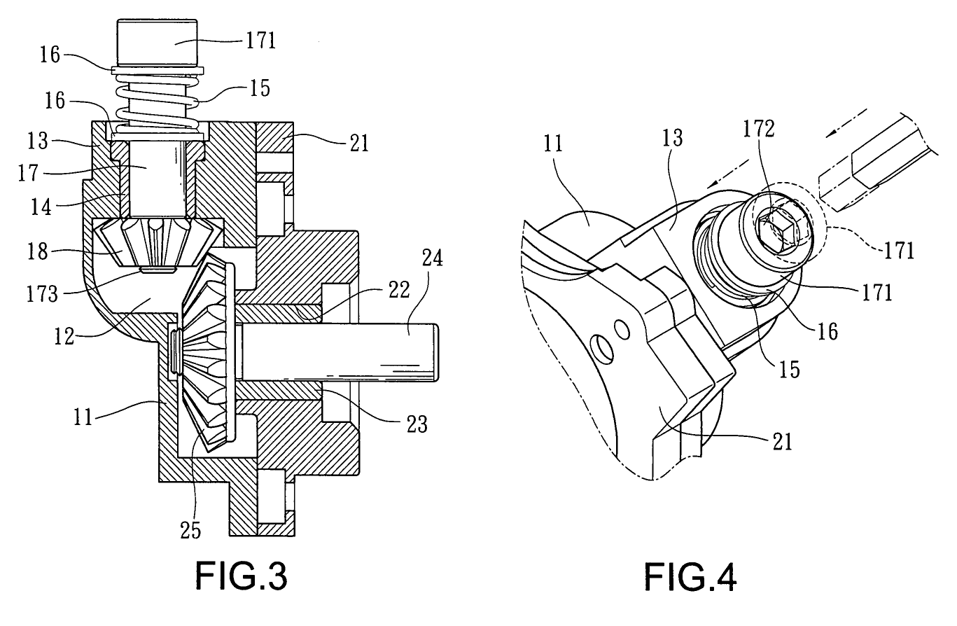

Referring to FIGS. 1, 2 and 3, which show the present invention structured to comprise a driving portion 1 and a driven portion 2.

The aforementioned driving portion 1 comprises a case 11, interior of which is provided with a hollow holding portion 12. A hollow shaft sleeve 13 is located on a circumference of the case 11 and assumes a 45 degree angle therewith; moreover, the hollow shaft sleeve 13 forms a passageway with the holding portion 12. A copper (brass) bush 14 is disposed in the hollow shaft sleeve 13, and a spring 15 and a washer 16 are positioned on an upper portion of the copper (brass) bush 14, moreover, a shaft 17 penetrates the hollow shaft sleeve 13, thereby assembling the shaft 17 at a 45 degree angle disposition on the case 11. Atop end of the shaft 17 is provided with a sleeve joint portion 171, and an inner hexagonal concavity portion 172 is defined in a top end of the sleeve joint portion 171. A left-handed screw crossbite (L) external screw thread 173 is formed on a bottom end of the shaft 17, which enables the external screw thread 173 to screw into a corresponding internal screw thread 181 formed at an axle center of the driving bevel gear 18, thereby positionally fixing the driving bevel gear 18 in the holding portion 12. Moreover, an elastic effect of the spring 15 positioned on an upper portion of the shaft 17 enables the driving bevel gear 18 to separate from a driven bevel gear 25 in the driven portion 2 and assume a disengaged state.

The driven portion 2 comprises a cover body 21 that covers an opening of the holding portion 12 of the aforementioned case 11. Moreover, a through hole 22 is defined center of the cover body 21, and a shaft sleeve 23 is fixedly embedded in the through hole 22. A central shaft 24 penetrates the shaft sleeve 23, and a left-handed screw crossbite (L) external screw thread 241 is formed on one end of the central shaft 24, which enables the external screw thread 241 to screw into a corresponding internal screw thread 251 formed at an axle center of the driven bevel gear 25, thereby configuring a remote control car starter having a engaging and disengaging structure.

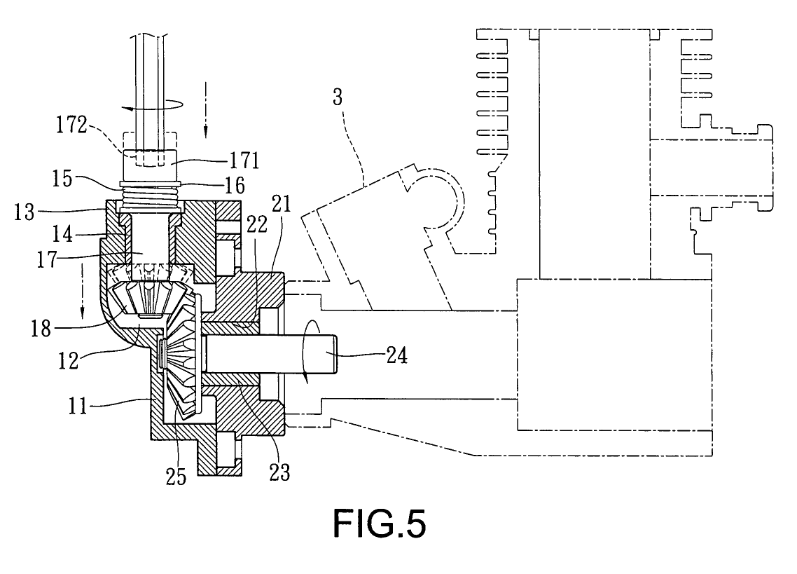

Referring to FIGS. 4 and 5, which show the present invention configured to one side of a remote control car engine 3, wherein an outer end of the central shaft 24 of the driven portion 2 is connected to a connecting portion of the remote control car engine 3. When a user wishes to start the remote control car engine 3, an end portion of an electric power tool carried by the user is end connected to a shaft having an outer hexagonal form and inserted into the sleeve joint portion 171 of the top end of the shaft 17 of the driving portion 1, which causes a mutual embedding and clamping of the shaft and the inner hexagonal concavity portion 172 of the sleeve joint portion 171, and simultaneously exerts a downward pressure that compresses the spring 15 and causes mutually meshing of the driving bevel gear 18 at the bottom end of the shaft 17 and the driven bevel gear 25 of the central shaft 24 of the remote control car engine 3. Hence, starting the power tool causes the shaft to rotate, which further actuates and rotates the shaft 17 of the driving portion I within the hollow shaft sleeve 13, thereby engaging rotation of the driving bevel gear 18 at the bottom end of the shaft 17 and causing mutual meshing between the driving bevel gear 18 and the driven bevel gear 25, which further engages rotation of the central shaft 24 of the driven bevel gear 25. Hence, the connecting portion of the remote control car engine 3 connected to the other end of the central shaft 24 is rotated (see FIG. 5). Because of the high rotating speed produced after starting the remote control car engine 3, thus, in order to prevent the user being unable to quickly withdraw the power tool due to human factors, the present invention configures the central shaft 24 and the connecting portion of the remote control car engine 3 to a unilateral bearing. Hence, after starting the remote control car engine 3, the unilateral bearing enables the central shaft 24 to assume a release state, thereby preventing human factors from affecting the remote control car engine 3.

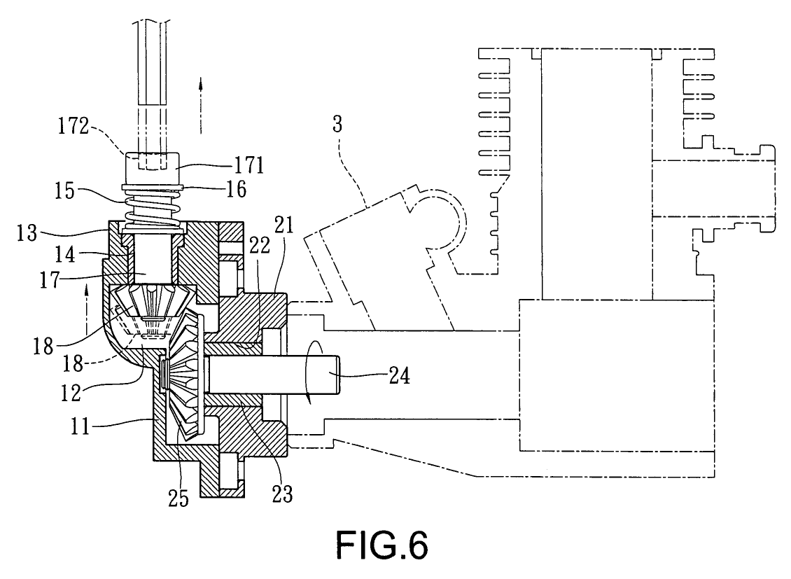

Referring to FIGS. 4 and 6, after the user withdraws the power tool from the shaft 17 of the driving portion 1, then the elastic restoring force effect of the spring 15 positioned on an upper portion of the shaft 17 causes the shaft 17 to upwardly spring back, which simultaneously causes the driving bevel gear 18 at the bottom end of the shaft 17 to upwardly separate from meshing with the driven bevel gear 25, thereby releasing output power of the remote control car engine 3 from being restrained by the driving portion 1, which would otherwise result in reduction in the output power.

In conclusion, the concise components and simple assembly of a remote control car starter with engaging and disengaging structure of the present invention is provided with an integral configuration that is innovative when compared to existing remote control car engine starter devices. Moreover, advancement in effectiveness can be clearly seen, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A remote control car starter with engaging and disengaging structure, which is configured to one side of a remote control car engine, comprises:
a driving portion comprising a case provided with a hollow holding portion, a hollow shaft sleeve is located on a circumference of the case and assumes a 45 degree angle therewith, moreover, the hollow shaft sleeve forms a passageway with the holding portion; a shaft, a top end of which is provided with a sleeve joint portion, penetrates the hollow shaft sleeve, and a driving bevel gear is configured to a bottom end of the shaft, a spring is installed on a bottom end of the sleeve joint portion of the shaft, which enables the driving bevel gear positionally fixed in the holding portion of the case and a driven bevel gear of a driven portion to assume a disengaged state;
the driven portion comprising a cover body that covers the holding portion of the case, moreover a through hole, fitted with a shaft sleeve, is defined in he cover body, a central shaft penetrates the shaft sleeve, and the driven bevel gear, which is able to mesh with the driving bevel gear, is configured to one end of the central shaft, another end of the central shaft is connected to a connecting portion of a remote control car engine.

2. The remote control car starter with engaging and disengaging structure according top claim 1, wherein a copper (brass) bush is configured between the shaft and the hollow shaft sleeve.

3. The remote control car starter with engaging and disengaging structure according top claim 1, wherein a left-handed screw crossbite external screw thread is formed on one end of the shaft, and a corresponding internal screw thread is formed at an axle center of the driving bevel gear, thereby enabling the external screw thread of the shaft to screw into the driving bevel gear.

4. The remote control car starter with engaging and disengaging structure according top claim 1, wherein an inner hexagonal concavity portion is defined in an end of the sleeve joint portion.

5. The remote control car starter with engaging and disengaging structure according top claim 1, wherein a washer is respectively disposed at two ends of the spring.

6. The remote control car starter with engaging and disengaging structure according top claim 1, wherein a left-handed screw crossbite external screw thread is formed on one end of the central shaft, and a corresponding internal screw thread is formed at an axle center of the driven bevel gear, thereby enabling the external screw thread of the central shaft to screw into the driven bevel gear.
